(19) United States
(12) Patent Application Publication
(10) Pub. No.: US 2010/0076082 A1
(43) Pub. Date: Mar. 25, 2010

(54) New Cleaning, Descaling and Disinfecting Composition for Dialysis Generators

(75) Inventors: Jean-Claude Gamet, Maizeray (FR); Daniel Le Rouzic, Ermont (FR); Jean-Benoit Mabille, La Charmee (FR); Marie-Pierre Pierre, Saint-Jean-De-Vaux (FR)

Correspondence Address: AIR LIQUIDE;Intellectual Property, 2700 POST OAK BOULEVARD, SUITE 1800, HOUSTON, TX, 77056, US

(73) Assignee: Bioxal, Paris (FR)

(21) Appl. No.: 12/595,186

(22) PCT Filed: Apr. 12, 2007
(86) PCT No.: PCT/FR2007/051099

§ 371 Date: Oct. 8, 2009

(51) Int. Cl. A01N 37/36

(52) U.S. Cl. 514/557

(57) ABSTRACT

Composition comprising, per 100% of its mass, essentially: from 0.50% by mass to 1.50% by mass of peracetic acid, from 3.00% by mass to 15.00% by mass of hydrogen peroxide, from 3.00% by mass to 15.00% by mass of acetic acid, from 0.10% by mass to 1.00% by mass of concentrated nitric acid, from 0.001% by mass to 0.20% by mass of nonionic surfactant, from 0.01% by mass to 0.10% by mass of amine oxide, from 0.01% by mass to 0.20% by mass of stabilizer, and water to make up to 100% by mass; use thereof for cleaning, descaling and disinfecting dialysis equipment between two successive dialysis sessions, without additional treatment other than rinsing of said dialysis equipment with osmosed water; methods for the use thereof.

The invention relates to the maintenance of dialysis machines and more particularly to their treatment between two uses.

The general principle of extracorporeal dialysis is based on exchanges through a semi-permeable membrane, between the blood to be purified and a dialysate having an electrolytic composition close to normal extracellular fluid, which is therefore composed of water and electrolytes in sufficient concentrations so that the concentration of electrolytes in the blood at the end of dialysis is normal. So that effective exchanges can be carried out, it is necessary to continuously renew the blood and the dialysate, since the rate of diffusion or of dialysis is a function of the concentration difference between these two liquids.

All dialysis machines are composed of a generator, a dialyzes, also known as an artificial kidney and a circuit of water. This assembly of components will be referred to in the following account as the hemodialysis line.

The role of the generator is to ensure the preparation of a dialysate heated to 37° C., by mixing water, a solution of electrolytes, the concentration of which does not allow the proliferation of infectious agents, and a buffer solution and to circulate the blood and the dialysate while controlling the dialysis parameters. Since the water used in these devices must be very pure and conform to the European Pharmacopeia, it undergoes a treatment that comprises a succession of steps, such as filtration, passing over ion-exchange resins, passing over activated carbon and finishing with reverse osmosis. There are different types of generators: there are those that use the open-circuit dialysate technique and that make it possible to obtain a dialysate of better bacteriological quality than those that use the technique known as closed-circuit technique in which there is re-circulation of the dialysate.

The role of the dialyzer is to remove water and organic waste products originating from the blood of the human body and that migrate from the blood to the dialysate through the semi-permeable membrane. This semi-permeable membrane may be arranged as plates, in compartments stacked on top of one another, in the form of coils, as a single compartment wound in a spiral around an axis or as sets of capillaries; this membrane may be organic made of cellophane, cuprophane, polysulfone, polypropylene, polyamide, polyacetate or made of an acrylonitrile copolymer. The dialyzer is delivered sterile and is often for single use, as in France; however, in some countries the dialyzer is reused.

As types of dialyzers, mention may be made of coil kidneys, comprising a parallel winding of two sheets of dialyzing membranes in a spiral around an axis, the blood circulating inside the envelope formed by the two sheets of the membrane and the dialysate on the outside, hollow-fiber kidneys that put up a very low resistance to the passage of the blood or plate kidneys comprising 15 to 20 sheets assembled as plates.

The use of aqueous solutions of peracetic acid for disinfecting all the components of the dialysis line was described many years ago. Mention may be made, for example, of L. J. Fischbach, AAMI Technol. Anal. Rev. (1905), pages 15 to 18; Von SpröBig at al. Dtsch. Ges.wesen 27 (1972), H 23 pages 1085-1009; or European Patent Applications published under the numbers EP 0 370 850, EP 0 873 687 and EP 1 068 873.

However, the desire of hospital, community or private patients to carry out both shorter and more effective dialysis sessions has led dialysis equipment manufacturers to use hemodialysis techniques other than conventional hemodialysis. In particular, hemofiltration and hemodiafiltration.

Conventional hemodialysis: according to this method, the transfer of solutes mainly takes place by diffusion, whereas that of sodium and of water takes place via a mainly convective method.

Hemofiltration: according to this method, the transfer of solutes is purely convective. Hemofiltration requires the use of a high-permeability membrane. The volemic balance (or total volume of the blood) of the patient is maintained, by reinjecting into the blood circuit a replacement solution having a composition close to that of a normal plasma ultrafiltrate at a flow rate equivalent to that of the ultrafiltration flow rate, reduced by the flow rate corresponding to the desired weight loss.

Hemodiafiltration: Hemodiafiltration combines both the properties of conventional hemodialysis and of hemofiltration: according to this method, the transport of the solutes is on the one hand by diffusion, which ensures an effective removal of low molecular weight waste substances and, on the other hand, convective, which increases the extraction of high molecular weight solutes. Hemodiafiltration therefore requires both a dialysate and a replacement solution.

On-line hemofiltration and hemodiafiltration techniques require large volumes of replacement solution. They rely on the extemporaneous production of this solution from the inflowing dialysate. But these new techniques, which use high-permeability membranes, lead to the appearance of protein and lipid deposits, which originate from the patients' blood, in the dialysate circuits of the generators. These deposits accumulate until they obstruct the water drainage systems and block the operation of the dialysis equipment.

Added to these technological advancements are the more restrictive regulatory advancements relating to the evaluation of the efficacy of disinfectants classed as “Medical Devices”.

These advancements therefore require the research and development of novel processes or products that result in complete hygiene of the dialysis equipment, that is to say impeccable cleaning, descaling and disinfection of all the components of the dialysis line.

Although peracetic acid solutions are widely used for their good disinfecting properties, they are however not sufficiently descaling and are absolutely not detergent.

This is the reason why the equipment is currently subjected to various (chemical or thermochemical) treatments, which are complementary to the disinfection and are carried out alternately, in order to obtain complete hygiene of the circuits. This alternation is a source of errors and of stress for the materials and requires a suitable organization.

The inventors have therefore sought to develop a chemical process that integrates the various functions of complete hygiene, without damaging secondary effects, and which is simple to use.

This is why one subject the invention is a composition comprising, per 100% of its mass, essentially:

from 0.50 wt % to 1.50 wt % of peracetic acid;
from 3.00 wt % to 15.00 wt % of hydrogen peroxide;
from 3.00 wt % to 15.00 wt % of acetic acid;
from 0.10 wt % to 1.00 wt % of concentrated nitric acid;
from 0.001 wt % to 0.20 wt % of non-ionic surfactant;
from 0.01 wt % to 0.10 wt % of amine oxide;
from 0.01 wt % to 0.20 wt % of stabilizer; and
water to make it up to 100 wt %.

As non-ionic surfactants suitable for use in the composition as defined previously, there are in particular those of formula (I):

R₅—O—[CH(R₈)—CH(R₆)—O]ₙ—R₇ (I)

in which R₅ represents a saturated or unsaturated, linear or branched aliphatic radical comprising from 5 to 31 carbon atoms and preferably from 10 to 16 carbon atoms, R₆ represents a hydrogen atom, a methyl radical or an ethyl radical, R₈ represents a hydrogen atom, a methyl radical or an ethyl radical, it being understood that at least one of the radicals R₆ or R₈ represents a hydrogen atom, R₇ represents a hydrogen atom, or a linear or branched alkyl radical comprising from 1 to 4 carbon atoms or a benzyl radical and n represents a number between 1 and 50, preferably below 20. The non-ionic surfactant is especially chosen from the following commercial products: GENAPOL™ EP 0244, GENAPOL™ EP 2564, GENAPOL™ NP 2584, TRITON™ DF12, TRITON™ DF16, TRITON™ CP10 or SIMULSOL™ NW 900. These products, which are commercially available, have the following chemical composition:

| Trade name | Chemical composition |
|---|---|
| GENAPOL ™ EP 0244 | Mixture of C₁₀, C₁₂ polyalkoxylated |
| | alcohols (4 EO, 4 PO) |
| GENAPOL ™ EP 2564 | Mixture of C₁₂, C₁₅ polyalkoxylated |
| | alcohols (6 EO, 4 PO) |
| GENAPOL ™ EP 2584 | Mixture of C₁₂, C₁₅ polyalkoxylated |
| | alcohols (8 EO, 4 PO) |
| TRITON ™ DF12 | Benzyl ethers of C₈, C₁₀, |
| | polyalkoxylated alcohols (2 EO, 5 PO) |
| TRITON ™ DF16 | Mixture of C₈, C₁₀ polyalkoxylated |
| | alcohols (6 EO, 3 PO) |
| TRITON ™ CF10 | Benzyl ether of C₈ polyalkoxylated |
| | alcohols (16 EO) |
| SIMULSOL ™ NW 900 | Mixture of polyalkoxylated alcohols (x |
| | EO, y PO) |

As amine oxides suitable for use in the composition as defined previously, there are especially those of formula (II):

(R₁)(R₂)(R₃)N→O (II)

in which R₁ represents a linear or branched aliphatic radical comprising from 8 to 18 carbon atoms and R₂ and R₃ each represent a methyl radical. In the formula (II) such that R₁ is more particularly chosen from octyl, decyl, dodecyl, tetradecyl or hexadecyl radicals. As compounds of formula (II) suitable for the present invention, there is, for example, cocodimethylamine oxide, such as that sold under the name AROMOX™ MCD-W, myrstamine oxide or dihydroxyethyl cocamine oxide.

As stabilizers that are suitable for such compositions, there are for example sequestering agents and/or free-radical scavengers such as those from the family of butylhydroxytoluenes. Mention may also be made of phosphonic acids such as, for example, 1-hydroxyethylidene-1,1-diphosphonic acid (HEDP).

The water used in the composition as defined previous is preferably a water that conforms to the European Pharmacopeia that has undergone a treatment that comprises a succession of steps, such as filtration, passing over ion-exchange resins and finishing with reverse osmosis.

According to one particular aspect of the present invention, the composition as defined previously comprises, per 100% of its mass, essentially:

from 0.50 wt % to 1.00 wt % of peracetic acid;
from 4.00 wt % to 10.00 wt % of hydrogen peroxide;
from 4.00 wt % to 15.00 wt % of acetic acid;
from 0.10 wt % to 1.00 wt % of concentrated nitric acid;
from 0.03 wt % to 0.10 wt % of non-ionic surfactant;
from 0.01 wt % to 0.10 wt % of amine oxide;
from 0.03 wt % to 0.10 wt % of stabilizer; and
water to make it up to 100 wt %.

According to another particular aspect of the present invention, the composition as defined previously comprises, per 100% of its mass, essentially:

from 0.70 wt % to 1.00 wt % of peracetic acid;
from 4.00 wt % to 7.00 wt % of hydrogen peroxide;
from 7.00 wt % to 12.00 of % of acetic acid;
from 0.20 wt % to 0.70 wt % of concentrated nitric acid;
from 0.03 wt % to 0.075 wt % of non-ionic surfactant;
from 0.01 wt % to 0.05 wt % of amine oxide;
from 0.03 wt % to 0.075 wt % of stabilizer; and
water to make it up to 100 wt %.

Another subject of the invention is a method of preparing the composition as defined previously, characterized in that it comprises a step of mixing, per 100 wt:

from 3 to 20 of an aqueous solution (A) comprising from 5 wt % to 30 wt % of peracetic acid, from 10 wt % to 50 wt % hydrogen peroxide, from 5 wt % to 60 wt % of acetic acid, optionally up to 1% of stabilizer, and water to make it up to 100 wt %, with from 80 wt % to 97 wt % of an aqueous solution (B) prepared by mixing, per 100 wt %:
from 8 wt % to 10 wt % of acetic acid;
from 0.10 wt % to 1 wt % of nitric acid;
from 3 wt % to 10 wt % of hydrogen peroxide;
from 0.03 wt % to 0.1 wt % of non-ionic surfactant;
from 0.01 wt % to 0.1 wt % of amine oxide;
from 0.005 wt % to 0.1 wt % of stabilizer; and
water to make it up to 100 wt %.

The solution (A) used in the method as defined above is prepared with commercial reactants such as, for example:

hydrogen peroxide in aqueous solution at 60 wt %;
glacial acetic acid at 99 wt %;
concentrated nitric acid at 58 wt %; and
the stabilizer from the HPDP family.

It is also possible to use a solution (A) at equilibrium, such as 15/23 solutions (15 with of peracetic acid; 23% of hydrogen peroxide) or 5/23 solutions (5 wt % of peracetic acid; 23% of hydrogen peroxide).

It is also possible to prepare the solution (A) used in the method as defined above via the method described in the European Patent Application published under the number EP 0 024 219, from commercial products.

Another subject of the invention is a method of cleaning, descaling and disinfecting the hydraulic circuits of the dialysis generator between two dialysis sessions, characterised in that it comprises:

a step (a) of circulating within the hydraulic circuits of said dialysis generator, over a time between 10 minutes and 30 minutes, an aqueous solution obtained by the dilution, between 1/20 and 1/40 in water osmosed by said generator, of a composition as defined previously, and at the end of step (a);
a step (b) of rinsing, consisting of the circulation within the hydraulic circuits of said dialysis generator, for a time between 15 minutes and 60 minutes, of osmosed water.

The expression “osmosed water” is understood to mean that the water used has previously undergone a purification treatment comprising a succession of steps, such as filtration, passing over ion-exchange resins, passing over activated carbon and the last step of which is a purification by reverse osmosis in order to achieve the values of the physicochemical and microbiological parameters required by the French and European Pharmacopeiae.

According to one particular aspect of the method as defined above, the dilution rate of the aqueous composition used is between 1/25 and 1/35.

Another subject of the invention is a method for cleaning, descaling and disinfecting the distribution loop of the water treatment line for hemodialysis, characterized in that it comprises:

a step (a) of circulating, within said distribution loop, for a time between 30 minutes and 60 minutes, an aqueous solution obtained by the dilution, between 1/20 and 1/40 in water, of a composition as defined in one of claims 1 to 3, and at the end of step (a);
a step (b) of rinsing a, the end of step consisting of the circulation within said distribution loop, for a time between 30 minutes and 60 minutes, of osmosed water.

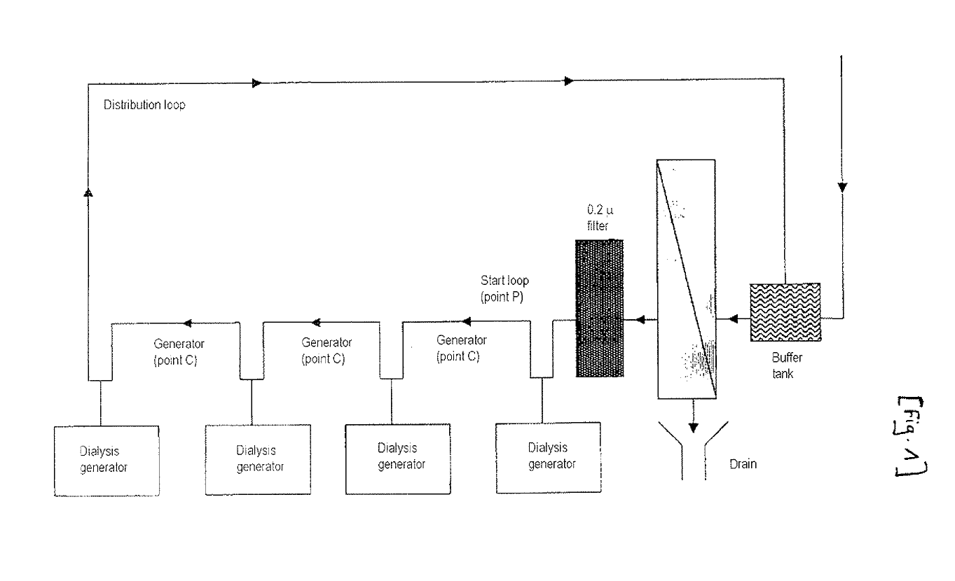

A water distribution loop for hemodialysis illustrated by FIG. 1.

The final subject of the invention is the composition as defined previously, for cleaning, descaling and disinfecting hydraulic circuits of the dialysis generator in a single operation between two successive dialysis sessions, without supplementary treatment other than a rinsing of said dialysis equipment with osmosed water.

The following experimental section illustrates the invention without however limiting it.

### A) PREPARATION OF A COMPOSITION 1 ACCORDING TO THE INVENTION

The composition 1 comprising 0.99 wt % of peracetic acid, 6.90 wt % of hydrogen peroxide, 10.40 wt % of acetic acid, 0.58 wt % of nitric acid, 0.05 wt % of GENAPOL™ EP 2564 (non-ionic surfactant), 0.015 wt % of cocodimethylamine oxide, 0.07 wt % of 1-hydroxyethylidene-1,1-diphosphonic acid and water to make it up to 100 wt %, was prepared, per 100 wt %, by mixing 22 wt % of an aqueous solution (A1) comprising, per 11.00% of its mass:

between 4.50 wt % and 5.10 wt % of peracetic acid;
between 12.00 wt % and 13.00 wt % of acetic acid;
between 25.00 wt % and 27.00 wt % of hydrogen peroxide;
around 0.50 wt % of a (60 wt %) solution of 1-hydroxyethylidene-1,1-diphosphonic acid;
with 88 wt % of a solution (B1) prepared, per 100% it mass, from:
between 8.00 wt % and 9.00 wt % of 99 wt % glacial acetic acid;
between 3.80 wt % and 4.00 wt % of 60 wt % hydrogen peroxide;
between 8.50 wt % and 9.00 wt % of 58 wt % concentrated nitric acid;
between 0.05 wt % and 0.06 wt % of GENAPOL™ EP 2564;
between 0.05 and 0.06 wt % of AROMOX™ MCD-W (30 wt % cocodimethylamine oxide); and around 0.006 wt % of a (60 wt %) solution of 1-hydroxyethylidene-1,1-diphosphonic acid.

### B) ANALYSIS OF THE DISINFECTING PROPERTIES OF THE COMPOSITION 1

The tests listed in the table below were carried out in order to confirm the bactericidal, fungicidal and virucidal efficacies of the composition 1 by comparing them with that of an aqueous solution at equilibrium comprising 0.42 wt % of peracetic acid, 7 wt % of hydrogen peroxide and 3.5 wt % to 1.5 wt % of acetic acid, which has been used for several years in dialysis centers as a disinfectant and descaler for dialysis generators. Certain tests were carried out at a 1/35 dilution corresponding to that used in the AK 200 Ultra™ generator from Gambro, following the provisions of the European or French standards, relevant in this particular case. The results are recorded in the following tables.

BACTERICIDAL EFFECT

| Contact time (Tc) | | Composition |
|---|---|---|
| Temperature (T) | | according to the |
| Operating conditions (CO) | DIALOX ™ | invention |
| (Test according to the NF | | |
| EN 1040 standard) | | |
| Tc: 5 minutes; T: 20° C. | CMB: 0.4% | CMB: 2.0% |
| CO: Absence of interfering | (18 ppm APA) | (20 ppm APA) |
| substance | | |
| (Test according to the NF | | |
| EN 13727 standard) | | |
| Tc: 5 minutes; T: 20° C. | CMB: 2.0% | CMB: 0.4% |
| CO: Clean conditions | (90 ppm APA) | (40 ppm APA) |
| Tc: 60 minutes; T: 20° C. | CMB: 2.0% | CMB: 0.4% |
| CO: Clean conditions | (90 ppm APA) | (40 ppm APA) |
| Tc: 5 minutes; T: 20° C. | — | CMB: 1% |
| CO: Dirty conditions | | (100 ppm APA) |
| Tc: 60 minutes; T: 20° C. | — | CMB: 1% |
| CO: Dirty conditions | | (100 ppm APA) |
| Tc: 5 minutes; T: 37° C. | — | CMB: 0.2% |
| CO: Clean conditions | | (20 ppm APA) |
| Tc: 5 minutes; T: 37° C. | — | CMB: 1% |
| CO: Dirty conditions | | (100 ppm APA) |

FUNGICIDAL EFFECT

| Contact time (Tc) | | Composition |
|---|---|---|
| Temperature (T) | | according to the |
| Operating conditions (CO) | DIALOX ™ | invention |
| NF EN 1275 standard | | |
| Tc: 15 minutes; T: 20° C. | CMF: 5.0% | CMF: 2.85% |
| CO: Absence of interfering | (225 ppm APA) | (285 ppm APA) |
| substance | | |
| NF EN 13624 standard | | |
| Tc: 10 minutes; T: 20° C. | | CMF: 4.0% |
| CO: Clean conditions | | (400 ppm APA) |
| Tc: 15 minutes; T: 20° C. | CMF: 5.0% | CMF: 3.0% |
| CO: Clean conditions | (225 ppm APA) | (300 ppm APA) |
| Tc: 60 minutes; T: 20° C. | CMF: 5.0% | CMF: 2.0% |
| CO: Clean conditions | (225 ppm APA) | (200 ppm APA) |
| Tc: 10 minutes; T: 20° C. | — | CMF: 6% |
| CO: Dirty conditions | | (600 ppm APA) |
| Tc: 15 minutes; T: 20° C. | — | CMF: 4% |
| CO: Dirty conditions | | (400 ppm APA) |
| Tc: 60 minutes; T: 20° C. | — | CMF: 2.85% |
| CO: Dirty conditions | | (285 ppm APA) |
| Tc: 10 minutes; T: 37° C. | — | CMF: 2.85% |
| CO: Clean conditions | | (285 ppm APA) |
| Tc: 15 minutes; T: 37° C. | — | CMF: 2.0% |
| CO: Clean conditions | | (200 ppm APA) |
| Tc: 10 minutes; T: 37° C. | — | CMF: 4.0% |
| CO: Dirty conditions | | (400 ppm APA) |
| Tc: 15 minutes; T: 37° C. | — | CMF: 2.85% |
| CO: Dirty conditions | | (285 ppm APA) |

CMB: minimum bactericide concentration;
APA: peracetic acid;
Clean conditions: 0.03% albumin;
Dirty conditions: 0.3% albumin + 0.3% sheep blood erythrocytes;
CMF: minimum fungicide concentration; the concentration of 2.85% corresponds to the conditions of use in the machine (=1/35 dilution).

VIRUCIDAL EFFECT

| Contact time (Tc) | | |
|---|---|---|
| Temperature (T) | | Composition |
| Operating conditions (CO) | | according to the |
| NFT 72-180 standard | DIALOX ™ | invention |
| Tc: 15 minutes; T: 37° C. | CMV: 4.0% | CMV: 1.5% |
| (Adenovirus type 5 | | |
| cultured on HeLa cell) | | |

The results demonstrate that under the usage conditions of generators (1/35 dilution), the composition 1 according to the invention is bactericidal according to the NF EN 13727 standard and fungicidal according to NF EN 13624 in 60 minutes at 20° C. under clean conditions, 60 minutes at 20° C. under dirty conditions, 10 minutes at 37° C. under clean conditions and 15 minutes at 37° C. under dirty conditions, while retaining the irritant classification (peracetic acid <1% and hydrogen peroxide <7%). They also demonstrate that the composition 1 according to the invention is virucidal according to the NFT 72-180 standard.

### C) TESTS OF THE COMPOSITION 1 IN A DIALYSIS GENERATOR

### 1) Rinseability Test

A first series of tests was carried out on an AK 200 Ultra™ dialysis generator from Gambro, the parameters of which linked to disinfection were the following: volume of disinfectant sucked up: 120 ml; disinfection time: 10 minutes (temperature between 37° C. and room temperature); total duration of the cycle (disinfection+rinsing): 41 min.

The absence of foam was verified visually during and after the disinfecting phase. The disinfecting cycle took place normally and no trace of foam was visible at the end of the rinsing step. At the end of the rinsing step the absence of any trace of disinfectant in the dialysate was verified before the dialysis session. The dialysate was prepared by the generator after a test period succeeding the disinfectant rinsing phase. The results are the following, on the basis of the various parameters taken as indicators considering the nature of the constituents permitting this complete hygiene of the surfaces:

| | H₂O₂ at the | H₂O₂ at the | | Surface | Conductivity |
|---|---|---|---|---|---|
| | end of the | end of the | | tension | in μS/cm at |
| | washing | test | H₂O₂ in the | in mN/m | the end of the |
| | (discharge) | period | dialysate | (dialysate) | test period |
| DIALOX | 2 ppm | 0 | 0 | 69.5 mN/m | 4.2 μS/cm |
| Composition 1 | 5 ppm | 0 | 0 | 68.5 mN/m | 4.2 μS/cm |
| (test 1) | | | | | |
| Composition 2 | 2 ppm | 0 | 0 | 70.1 mN/m | 4.2 μS/cm |
| (test 2) | | | | | |

The absence of any trace of disinfectant is demonstrated. Since the initial conductivity (disinfecting solution) is around 1200 μS/cm (for a 1/35 dilution), this parameter can be used as an indicator before the start of the disinfection and as an indicator of the end of rinsing. These results demonstrate the good rinseability of the composition 1 according to the invention.

### 2) Validation of the Rinseability of the Composition 1 Under Usage Conditions Over a Period of 5 Days

A second series of tests was carried out over a period of 5 days to assess the good rinseability of the composition 1 according to the invention within hydraulic circuits of the AK 200 Ultra™ dialysis generator from Gambro, under the same experimental conditions as those stated in the preceding paragraph.

The composition 1 was used during this period twice a day with the same dialysis generator, said generator being kept at a standstill between two tests, with osmosed water within its hydraulic circuits.

Withdrawals of rinsing water were analyzed daily. They made it possible to attest to the constant and continuous rinseability of the composition 1 according to the invention.

The same test series was carried out on a FRESENIUS 4000 H™ generator from Frésénius operating with a 1/25 dilution, for a period of 5 days. They gave results that also conform to the required rinseability criteria.

### 3) Validation of the Cleaning and Disinfecting Power of the Composition 1 According to the Invention Over a Period of 9 Months

The composition 1 was used during this period between each dialysis over a period of nine months in a battery of 16 AK 200 Ultra™ dialysis generators from Gambro, operating in hemodiafiltration. The composition 1 diluted to 1/35 in the machine, was left at a standstill in the circuits of the generator each night between the days of dialysis sessions. Withdrawals of rinsing water were analyzed daily. Dialysate samples were withdrawn every two days at various locations of the circuits for a bacteriological analysis (R2A agar T 20/232° C.) and research for endotoxins (final gel point with successive dilutions to the halfway point; sensitivity of the reactant: 0.015 UI/ml). They led to the results recorded in the following table:

| | | | Hemo- | Hemo- |
|---|---|---|---|---|
| | Start of | Return of | diafiltration | diafiltration |
| | the loop | the loop | dialysate | reinjection |
| Bacteriology | N.T.R. | N.T.R. | N.T.R. | N.T.R. |
| at 48 hours | Free of pathogens | | | |
| Bacteriology | N.T.R. | N.T.R. | N.T.R. | N.T.R. |
| at 7 days | Free of pathogens | | | |
| Endotoxins | <0.015 | <0.015 | <0.015 | N.T.R. |
| | UI/ml | UI/ml | UI/ml | |

N.T.R.: Nothing to report

They demonstrate the absence of bacteria or endotoxins. Visual observations confirm the absence of scale and/or solid residues in the circuit.

The use of a composition 1 according to the invention for treating dialysis machines therefore results in the following advantages:
reduction in the down time of the dialysis equipment between two sessions;
the removal of any soiling of organic nature by iterative application, that is to say between each patient;
the removal of any soiling of funeral nature by iterative application, that is to rev between each patient;
supplementary safety for complete owing to the conductivity of the dilute aqueous solution being sufficient to be used as a marker (in disinfection and after rinsing) by the dialysis equipment;
conformity to the new standards for evaluating the disinfecting activity for the disinfectants for the circuits of dialysis generators;
the classification of the product as simply irritant due to the synergy of action of its constituents;
the innocuousness with respect to the equipment; and
the absence of foam and of any residue after the rinsing phase.

1-8. (canceled)

9. A composition comprising, per 100% of its mass:
from 0.50 wt % to 1.50 wt % of peracetic acid;
from 3.00 wt % to 15.00 wt % of hydrogen peroxide;
from 3.00 wt % to 15.00 wt % of acetic acid;
from 0.10 wt % to 1.00 wt % of concentrated nitric acid;
from 0.001 wt % to 0.20 wt % of non-ionic surfactant;
from 0.01 wt % to 0.10 wt % of amine oxide;
from 0.01 wt % to 0.20 wt % of stabilizer; and
water to make it up to 100 wt %.

10. The composition of claim 9, wherein the composition comprises, per 100% of its mass:
the peracetic acid is present in an amount from 0.50 wt % to 1.00 wt %;
the hydrogen peroxide is present from 4.00 wt % to 10.00 wt %;
the acetic acid is present from 4.00 wt % to 15.00 wt %;
the concentrated nitric acid is present in an amount from 0.10 wt % to 1.00 wt %;
the non-ionic surfactant is present in an amount from 0.03 wt % to 0.10 wt %;
the amine oxide is present in an amount from 0.01 wt % to 0.10 wt %;
the stabilizer is present in an amount from 0.03 wt % to 0.10 wt %; and
the remaining amount up to 100 wt % is water.

11. The composition of claim 10, wherein the composition comprises, per 100% of its mass:
the peracetic acid is present in an amount from 0.70 wt % to 1.00 wt %;
the hydrogen peroxide is present in an amount from 4.00 wt % to 7.00 wt %;
the acetic acid is present in an amount from 7.00 wt % to 12.00 wt %;
the concentrated nitric acid is present in an amount from 0.20 wt % to 0.70 wt %;
the non-ionic surfactant is present in an amount from 0.03 wt % to 0.075 wt %;
the amine oxide is present in an amount from 0.01 wt % to 0.05 wt %;
the stabilizer is present in an amount from 0.03 wt % to 0.075 wt %; and
the remaining amount up to 100 wt % is water.

12. A method for preparing a composition comprising, per 100% of its mass:
from 0.50 wt % to 1.50 wt % of peracetic acid;
from 3.00 wt % to 15.00 wt % of hydrogen peroxide;
from 3.00 wt % to 15.00 wt % of acetic acid;
from 0.10 wt % to 1.00 wt % of concentrated nitric acid;
from 0.001 wt % to 0.20 wt % of non-ionic surfactant;
from 0.01 wt % to 0.10 wt % of amine oxide;
from 0.01 wt % to 0.20 wt % of stabilizer; and
water to make it up to 100 wt %;
said method comprising a step of mixing, per 100 wt %, from 3 wt % to 20 wt % of an aqueous solution (A) that comprises from 5 wt % to 30 wt % of peracetic acid, from 10 wt % to 50 wt % of hydrogen peroxide, from 5 wt % to 60 wt % of acetic acid, optionally up to 1% of stabilizer, and water to make the aqueous solution (A) up to 100 wt %, with from 80 vol % to 97 vol % of an aqueous solution (B) prepared by mixing, per 100 wt % from 8 wt % to 10 wt % of acetic acid, from 0.10 wt % to 1 wt % of nitric acid, from 3 wt % to 10 wt % of hydrogen peroxide, from 0.03 wt % to 0.1 wt % of non-ionic surfactant, from 0.01 wt % to 0.1 wt % of amine oxide, from 0.005 wt % to 0.1 wt % of stabilizer; and water to make the aqueous solution (B) up to 100 wt %.

13. A method of cleaning, descaling and disinfecting the hydraulic circuits of the dialysis generator between two dialysis sessions, wherein the method comprises the steps of:
(a) circulating an aqueous solution obtained by the dilution of a composition comprising, per 100% of its mass:
from 0.50 wt % to 1.50 wt % of peracetic acid;
from 3.00 wt % to 15.00 wt % of hydrogen peroxide;
from 3.00 wt % to 15.00 wt % of acetic acid;
from 0.10 wt % to 1.00 wt % of concentrated nitric acid;
from 0.001 wt % to 0.20 wt % of non-ionic surfactant;
from 0.01 wt % to 0.10 wt % of amine oxide;
from 0.01 wt % to 0.20 wt % of stabilizer; and
water to make it up to 100 wt %,
within the hydraulic circuits of the dialysis generator for a period of time between 10 minutes and 30 minutes, the dilution of the composition being between 1/20 and 1/40 in water osmosed by the generator,
and at the end of step (a);
(b) rinsing for a time between 15 minutes and 60 minutes, the rinsing consisting of the circulation of osmosed water within the hydraulic circuits of the dialysis generator.

14. The method of claim 13, wherein the dilution rate of the aqueous composition used is between 1/25 and 1/35.

15. A method for cleaning, descaling and disinfecting the distribution loop of a water treatment line for hemodialysis, wherein the method comprises the steps of:
(a) circulating an aqueous solution obtained by the dilution of a composition comprising, per 100% of its mass:
from 0.50 wt % to 1.50 wt % of peracetic acid;
from 3.00 wt % to 15.00 wt % of hydrogen peroxide;
from 3.00 wt % to 15.00 wt % of acetic acid;
from 0.10 wt % to 1.00 wt % of concentrated nitric acid;
from 0.001 wt % to 0.20 wt % of non-ionic surfactant;
from 0.01 wt % to 0.10 wt % of amine oxide;
from 0.01 wt % to 0.20 wt % of stabilizer; and
water to make it up to 100 wt %,
within the distribution loop for a period of time between 30 minutes and 60 minutes, the dilution of the composition being between 1/20 and 1/40 in water,
and at the end of step (a);
(b) rinsing for a time between 30 minutes and 60 minutes, the rinsing consisting of the circulation of osmosed water within the distribution loop.

16. The use of a composition comprising, per 100% of its mass:
from 0.50 wt % to 1.50 wt % of peracetic acid;
from 3.00 wt % to 15.00 wt % of hydrogen peroxide;
from 3.00 wt % to 15.00 wt % of acetic acid;
from 0.10 wt % to 1.00 wt % of concentrated nitric acid;
from 0.001 wt % to 0.20 wt % of non-ionic surfactant;
from 0.01 wt % to 0.10 wt % of amine oxide;
from 0.01 wt % to 0.20 wt % of stabilizer; and
water to make it up to 100 wt %.
for cleaning, descaling and disinfecting dialysis equipment between two successive dialysis sessions, without the need for supplementary treatment other than a rinsing of the dialysis equipment with osmosed water.
